(19) United States
(12) Patent Application Publication
(10) Pub. No.: US 2013/0342185 A1
(43) Pub. Date: Dec. 26, 2013

(54) POWER SUPPLYING APPARATUS AND CONTROL METHOD THEREOF

(71) Applicants: Kazuaki Kunihiro, Tokyo (JP); Shinichi Hori, Tokyo (JP); Masaaki Tanio, Tokyo (JP)

(72) Inventors: Kazuaki Kunihiro, Tokyo (JP); Shinichi Hori, Tokyo (JP); Masaaki Tanio, Tokyo (JP)

(73) Assignee: NEC CORPORATION, Minato-ku, Tokyo (JP)

(21) Appl. No.: 14/002,866

(22) PCT Filed: Feb. 28, 2012
(86) PCT No.: PCT/JP2012/055499

§ 371 Date: Sep. 3, 2013

(30) Foreign Application Priority Data
Mar. 3, 2011 (JP) 2011-046502

(51) Int. Cl. G05F 1/618

(52) U.S. Cl. CPC G05F 1/618
USPC 323/284

(57) ABSTRACT

In order to improve power efficiency, a power supplying apparatus includes a switching amplification unit supplying a first load with most of electric power, and a linear amplification unit correcting an output voltage applied to the first load according to an input signal. Furthermore, an electric current which flows into the linear amplification unit at the time of the correcting is supplied to a second load from a power supply terminal of the linear amplification unit.

### TECHNICAL FIELD

The present invention relates to a power supplying apparatus and a control method thereof.

### BACKGROUND ART

The digital modulation method applied to the recent wireless communication such as the cellular phone and the wireless LAN (Local Area Network) adopts the modulation format such as QPSK (Quadrature Phase Shift Keying), multi-level QAM (Quadrature Amplitude Modulation) or the like. According to the modulation format, a locus of a signal is amplitude-modulated when a transition between symbols is generated. And, an amplitude (envelope) of a high frequency modulation signal superposed on a carrier signal of the microwave band changes as a time elapses. Here, a ratio of peak electric power to average electric power of the high frequency modulation signal is called PAPR (Peak-to-Average Power Ratio). In the case of amplifying a signal whose PAPR is large, in order to secure accurate linearity, it is necessary to supply an amplifier with sufficiently large electric power from a power supply so as not to make a signal waveform distorted even at a time of peak electric power. In the other words, it is necessary to make the amplifier work with a margin (back off), that is, to make the amplifier work in an electric power domain lower enough than the saturation electric power limited by a power supply voltage. Generally, since a class A or a class B linear amplifier has the maximum electric power efficiency in a vicinity of the saturation output electric-power, average efficiency is low in the case of making the amplifier work at an area where the back off is large.

In the case of the multi-carrier OFDM (Orthogonal Frequency Division Multiplexing) method which the next-generation cellular phone, the wireless LAN, and the digital television broadcasting adopt, PAPR has a tendency to become very large, and consequently the average efficiency of the amplifier is degraded furthermore. Accordingly, it is desirable as characteristics of the amplifier to have high efficiency even at the area where the back off is large.

As a method to amplify a signal at the area where the back off is large, and in a wide dynamic range, the EER (Envelope Elimination and Restoration) method and the ET (Envelope Tracking) method are known.

In the case of the EER method, firstly, an input modulation signal is divided into a phase component and an amplitude component. The phase component is inputted into an electric power amplifier with making phase modulation information unchanged and making an amplitude constant. At this time, the electric power amplifier is always operated near the saturation point used as the maximum in efficiency. Meanwhile, the amplitude component changes an output voltage of a power supplying apparatus on the basis of amplitude modulation information, and the output voltage is used as a power supply of the electric power amplifier. By carrying out the above-mentioned operation, the electric power amplifier works as a multiplier, and then the phase component and the amplitude component of the modulation signal are combined. As a result, it is possible to obtain an output modulation signal with no relation to the back off and with high efficiency.

On the other hand, a configuration, in which an amplitude component of an input modulation signal makes an output voltage of a power supplying apparatus changed on the basis of amplitude modulation information and the changed output voltage is used as the power supply of the electric power amplifier, according to the ET method is the same as the configuration according to the EER method. A different point of the ET method from the EER method is that, while only the phase modulation signal whose amplitude is constant is inputted into the electric power amplifier and the electric power amplifier is worked in a state of saturation according to the EER method, the input modulation signal which includes both the amplitude modulation and the phase modulation is inputted into the electric power amplifier as it is and the electric power amplifier is worked linearly according to the ET method. In this case, since the electric power amplifier works linearly, electric power efficiency of the ET method is more inferior than one of the EER method. However, since only the necessary and minimum electric power is supplied to the electric power amplifier according to the amplitude of the input modulation signal, it is possible to obtain high electric-power efficiency in comparison with the case that the electric power amplifier is worked by use of the constant voltage and with no relation to the amplitude. Furthermore, the ET method has an advantage that a timing margin for combining the amplitude component and the phase component is eased, and consequently realization of the ET method is easy in comparison with the EER method.

Here, it is necessary that a modulation power supplying apparatus is used in the EER method and the ET method can change an own output voltage with accuracy, low noise, and high efficiency according to the amplitude component of the input modulation signal. The reason is that in the case of the wireless communication method such as the cellular phone which uses the recent digital modulation, it is specified by the standard that ACPR (Adjacent Channel Leakage Power Ratio) and EVM (Error Vector Magnitude) should be suppressed so as to be not larger than a predetermined value. In the case that an output voltage of the electric power supplying apparatus is not linear to an input amplitude signal, ACPR and EVM are degraded by the cross-modulation distortion. When noise of the power supplying apparatus is mixed with an output of the amplifier, ACPR is also degraded. In the case of the EER method and the ET method, it is generally considered necessary that a response bandwidth (speed) of the power supplying apparatus is at least two times wider (higher) than a bandwidth (speed) of the modulation signal. For example, the modulation bandwidth based on the WCDMA (Wideband Code Division Multiple Access) specification of the cellular phone is about 5 MHz, and the modulation bandwidth based on the IEEE802.11a/g specification of the wireless LAN is about 20 MHz. It is difficult that the usual power supplying apparatus which has a configuration including a switching converter outputs the above broad bandwidth modulation signal. Here, IEEE used in the above description is an abbreviation of Institute of Electrical and Electronic Engineers.

In order to realize a voltage source with high efficiency and superior quality, two basic configurations of a hybrid voltage source which combines a switching amplification unit with high efficiency and a linear amplification unit with superior accuracy are disclosed in a non-patent literature 1.

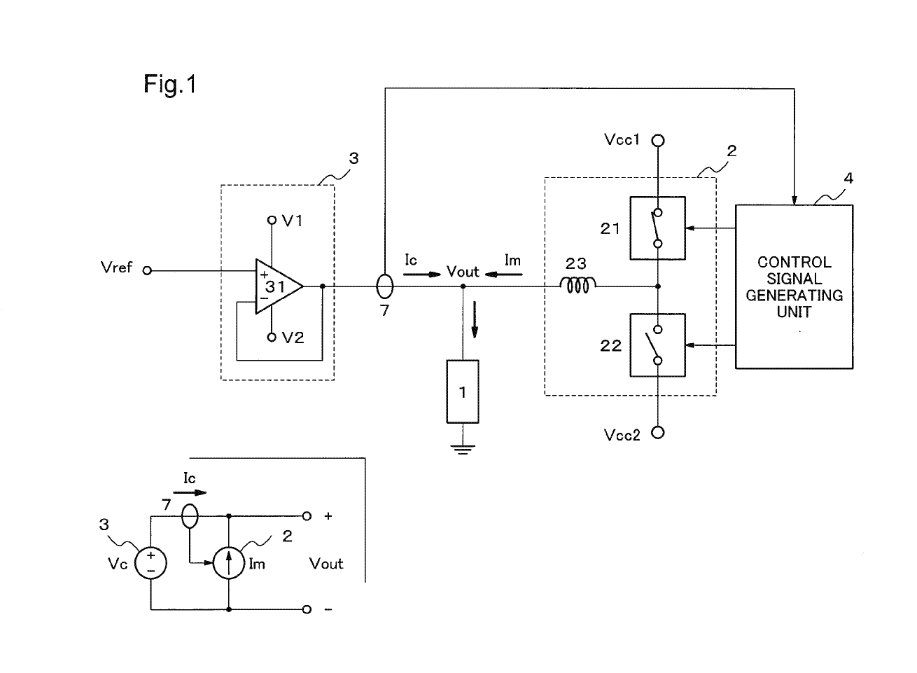

FIG. 1 is a block diagram showing a first hybrid voltage source described in the non-patent literature 1. The first hybrid voltage source connects a switching amplification unit 2 which works as a current source, and a linear amplification unit 3 which works as a voltage source in parallel. In this configuration, the linear amplification unit 3 with superior accuracy has a function to correct an output voltage Vout so as to be equal to a reference signal Vref. Meanwhile, switching elements 21 and 22 included in the switching amplification unit 2 are controlled by a control signal generating unit 4 on the basis of an output electric current Ic of the linear amplification unit 3 detected by an electric current detecting resistor 7. By carrying out the above-mentioned operation, the switching amplification unit 2 can work as the current source. Most of electric power supplied to a load 1 is supplied by the switching amplification unit 2 with high efficiency. Here, the linear amplification unit 3, which has superior accuracy but low efficiency, consumes only electric power which is almost equivalent to electric power for removing a ripple included in the output voltage Vout. Accordingly, the first hybrid voltage source can make both of superior accuracy and high efficiency compatible.

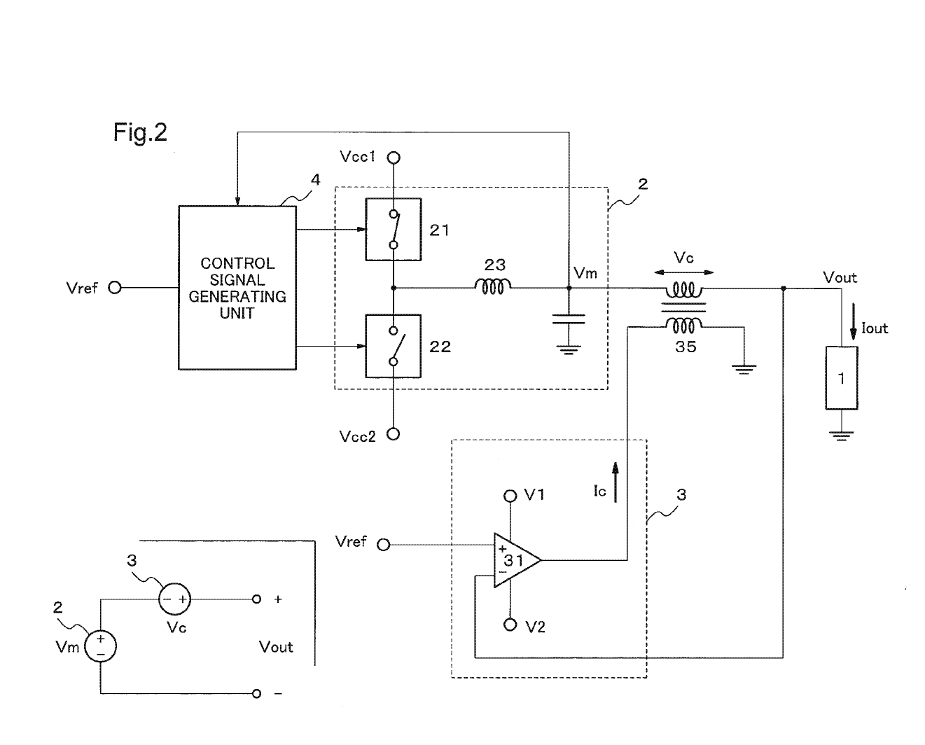

FIG. 2 is a block diagram showing a second hybrid voltage source described in the non-patent literature 1. The second hybrid voltage source connects the switching amplification unit 2 and the linear amplification unit 3 in series. Also in the case of the configuration, the linear amplification unit 3 with superior accuracy has a function to correct the output voltage Vout so as to be equal to the reference signal Vref by use of a feedback loop. Meanwhile, the switching amplification unit 2 feeds back an own output voltage Vm to the control signal generating unit 4 so that the output voltage Vm may be almost equal to the reference signal Vref (or output voltage Vout obtained by scaling the reference voltage Vref linearly). The switching elements 21 and 22 included in the switching amplification unit 2 are controlled by the control signal generating unit 4. An output Vc of the linear amplification unit 3 is added to the output voltage Vm of the switching amplification unit 2 in series, for example, through a transformer 35. By carrying out the above-mentioned operation, most of the electric power supplied to the load 1 is supplied by the switching amplification unit 2 with high efficiency. Here, the linear amplification unit 3 which has superior accuracy but low efficiency consumes only the electric power which is almost equivalent to the electric power for removing the ripple included in the output voltage. Accordingly, the second hybrid voltage source can make both of superior accuracy and high efficiency compatible.

A configuration of the hybrid voltage source which combines the switching amplification unit and the linear amplification unit is classified into the configurations shown in FIG. 1 and FIG. 2.

An amplifier which applied the configuration of the first hybrid voltage source shown in FIG. 1 to the power supplying apparatus according to the ET method is proposed in a non-patent literature 2.

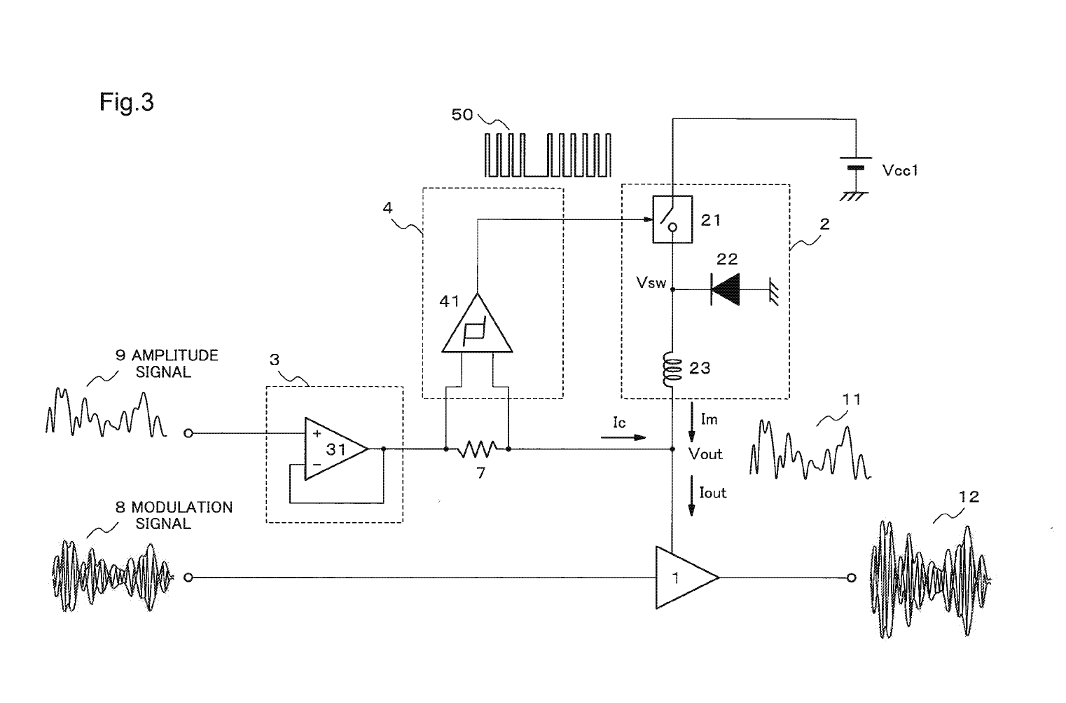

FIG. 3 is a block diagram showing the amplifier according to the ET method. In the amplifier according to the ET method, an amplitude signal 9 of the modulation signal is inputted at a position where the reference signal Vref is inputted in FIG. 1. An obtained modulation signal 11 which has high efficiency and a broad bandwidth is supplied as a power supply of the electric power amplifier (load 1).

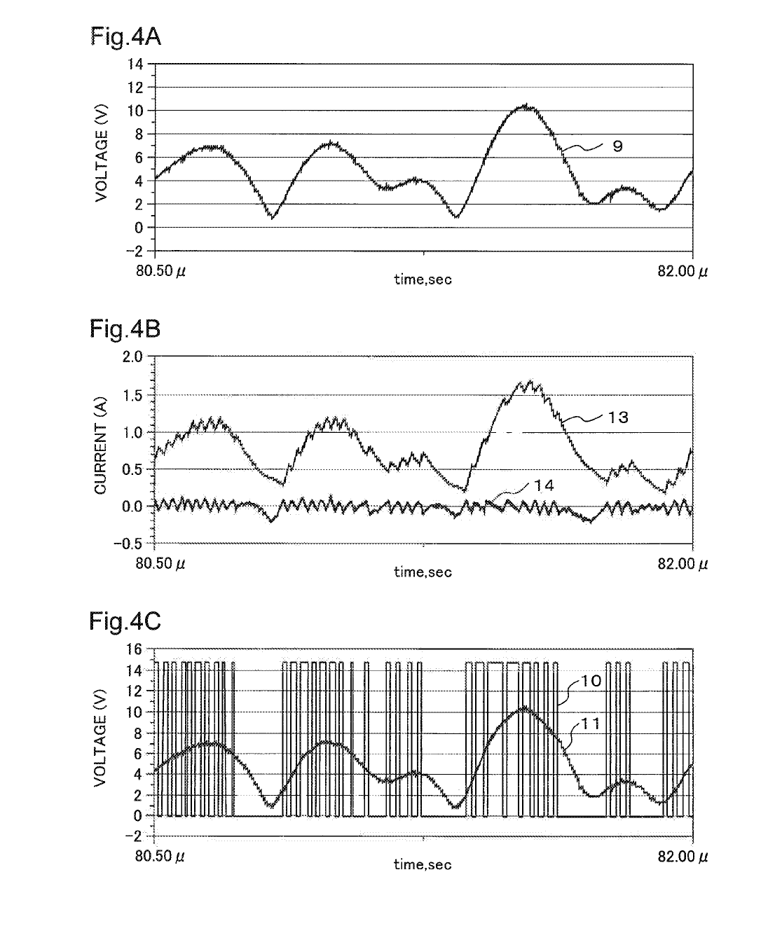

FIG. 4 is a waveform diagram for explaining an operation of the above-mentioned amplifier according to the ET method shown in FIG. 3. FIG. 4(a) shows a waveform of the amplitude signal 9. In FIG. 4(b), a code 13 indicates a waveform of a switching electric current Im, and a code 14 indicates the output electric current Ic of a voltage follower 3 (output current Ic of the linear amplification unit 3). In FIG. 4(c), a code 10 indicates a waveform of a switching voltage Vsw (refer to FIG. 3), and a code 11 indicates a waveform of the modulation voltage 11 (refer to FIG. 3). Hereinafter, a specific operation of the above-mentioned amplifier according to the ET method will be described by use of FIG. 1, FIG. 3 and FIG. 4.

The amplitude signal 9 is inputted to the voltage follower 3 (linear amplification unit 3) including an operational amplifier 31. Here, an envelope of the WCDMA downlink signal is used (refer to 9 shown in FIG. 4(a)) as the amplitude signal 9. The output electric current Ic of the voltage follower 3 is converted into a voltage by the electric current detecting resistor 7, and afterward the voltage is inputted to a hysteresis comparator 41 included in the control signal generating unit 4. At this time, by selecting a polarity so as to be High when an electric current flows from the voltage follower 3 (Ic>0), and to be Low when the electric current flows into the voltage follower 3 (IC<0), an output of the hysteresis comparator 41 is a pulse width modulation signal 50 according to a magnitude of the amplitude signal 9. This signal is used as a control signal of the switching element 21. Typically, the switching element 21 is composed of MOSFET (Metal Oxide Semiconductor Field Effect Transistor) or the like. The switching element 21 together with a diode 22 composes a switching converter. In the case that the pulse width modulation signal 50 is High, the switching element 21 is turned on (conductive state), and an electric current flows from a power supply Vcc1 toward the electric power amplifier (load 1). In this case, the switching voltage Vsw is identical with Vcc1 (in this case, Vcc1 is set to 15V) (refer to the waveform ndicated by the code 10 in FIG. 4(c)). The electric current from the switching element 21 is integrated by passing an inductor 23 (here, inductance is set to 0.6 μH), and the integrated electric current whose switching frequency component is removed is corresponding to the switching electric current Im.

Since Ic at a terminal for the output voltage Vout is expressed by a formula of Ic=Iout−Im, in the case that the switching current Im is excessive in comparison with an output electric current lout which flows through the electric power amplifier (load 1), the output current Ic of the voltage follower 3 (output current of the linear amplification unit) flows reversely (Ic<0), and starts flowing in a direction toward the operational amplifier 31. As a result, the polarity of the hysteresis comparator 41 is reversed to be Low, and then the switching element 21 is turned off (non-conductive state). At this time, in order to maintain the electric current which flows through the inductor 23, the electric current Im flows from GND to the electric power amplifier (load 1) through the diode 22. Moreover, potential of a cathode of the diode 22 (that is, the switching voltage Vsw) is 0V (refer to the waveform indicated by the code 10 in FIG. 4(c)). The above-mentioned switching operation is repeated and the switching electric current Im is supplied from Vcc1 or from GND alternately to the electric power amplifier (load 1) (refer to the waveform indicated by the code 13 in FIG. 4(b)). While an error component due to switching is included in the switching electric current Im, the voltage follower 3 carries out voltage correction. As a result, the modulation voltage 11 (refer to the waveform indicated by the code 11 in FIG. 4(c)) as the output signal is reproduced accurately and supplied to the electric power amplifier (load 1) after being amplified.

In a series of these operations, the electric current Ic (refer to the waveform indicated by the code 14 in FIG. 4(b)) which flows through the inefficient operational amplifier 31 includes only the error component. Accordingly, since power consumption of the linear amplification unit 3 is small and most of the input signal is amplified by the high-efficient switching amplification unit 2, it is possible to make efficiency of the power supplying apparatus high.

By using the output voltage Vout obtained by carrying out the above-mentioned operation as the power supply of the electric power amplifier (load 1), and carrying out the above-mentioned EER operation or the ET operation, only the minimum electric power is supplied from the power supplying apparatus according to the amplitude of the input modulation signal. Accordingly, the electric power amplifier (load 1) always works at the saturation area where efficiency is high, and also electric power efficiency of a whole of a transmitter system equipped with the power supplying apparatus and the electric power amplifier is improved.

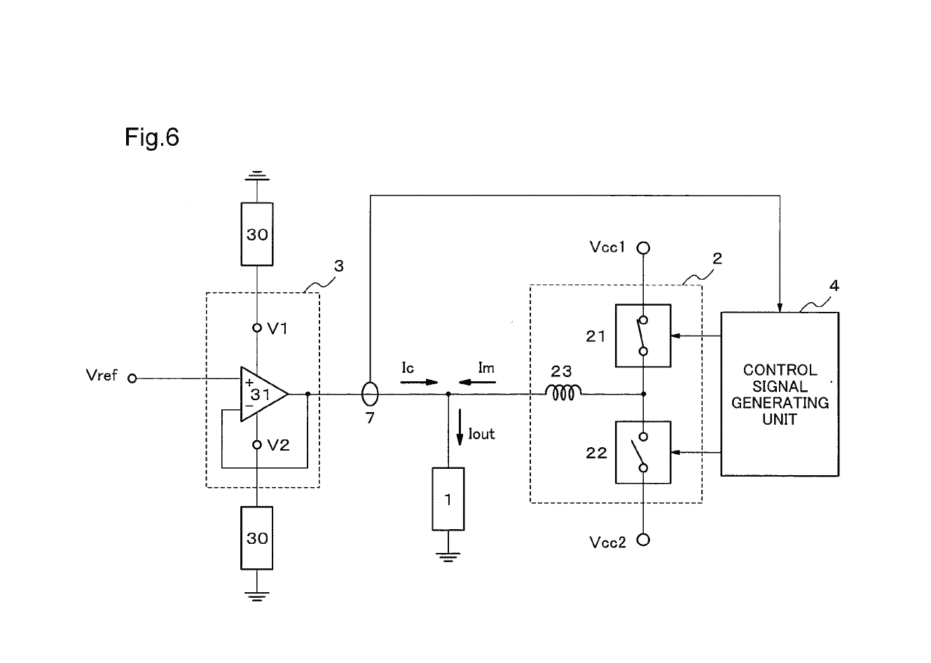

### NON-PATENT LITERATURE

[Non-patent literature 1] IEEE TRANSACTIONS ON POWER ELECTRONICS (1986, VOL.PE-1, NO. 1, pp. 48-54, FIG. 1)

[Non-patent literature 2] IEEE MTT-S Digest (2004, Vol. 3, pp. 1543-1546, FIG. 6)

### DISCLOSURE OF THE INVENTION

### Problem to be Solved by the Invention

In order to realize high efficiency of the amplifier (transmitter) shown in FIG. 3, it is desirable to make a switching frequency of the switching element 21 as high as possible in comparison with a modulation bandwidth of the amplitude signal 9 as the input signal, and to reduce the electric current flowing through the operational amplifier 31, by reducing the switching error included in the switching current Im.

However, in the case that the above-mentioned circuit configuration is applied to an apparatus such as the base station of the cellular phone which uses a large amount of the electric power, the power supply voltage Vcc1 will be several tens volt. It is generally considered difficult to switch such a large amplitude signal at a high speed and with small loss. The reason is that the switching element 21 (for example, MOSFET) and the diode 22 included in the switching amplification unit have an output parasitic capacitor Cp. In the case of switching under the condition of a power supply voltage V and a switching frequency fsw, electric power loss of Cp*V2*fsw is caused. Accordingly, as the power supply voltage V and the switching frequency fsw become large, the electric power loss also becomes large and consequently efficiency of the switching amplification unit 2 is degraded.

Accordingly, it is conceivable to make a value of the inductor 23 large in order to lower the switching frequency.

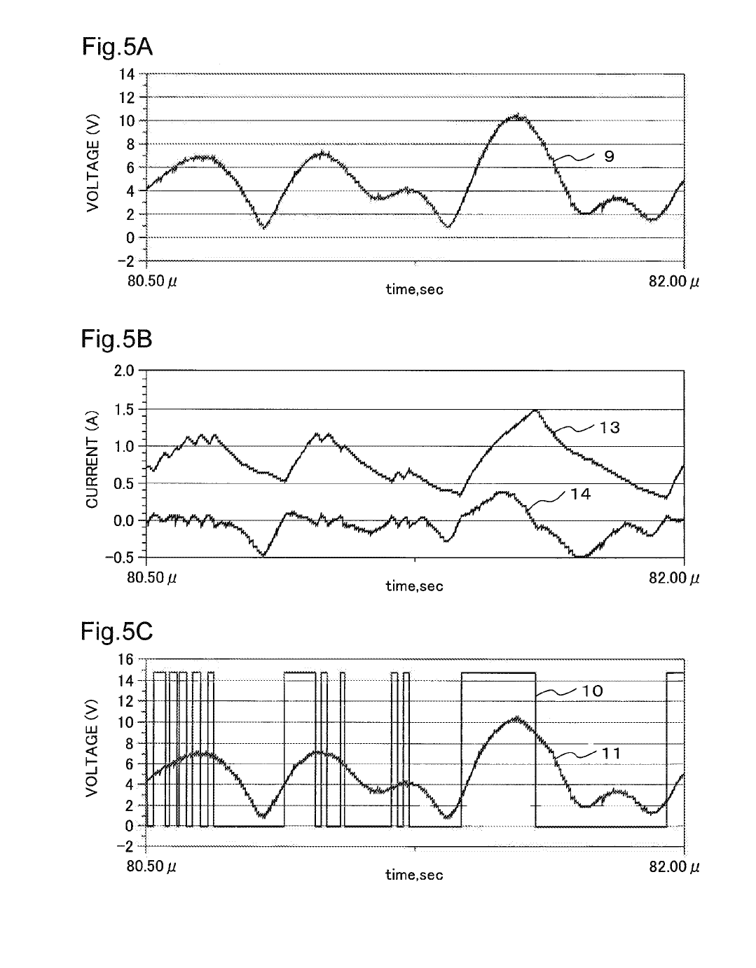

FIG. 5 shows an operational waveform of the above-mentioned amplifier according to the ET method shown in FIG. 3 obtained in the case of making the value of the inductor 23 two times large (that is, 2*L0=1.2 μH). If comparing a waveform indicated by a code 10 in FIG. 5(c), and the waveform indicated by the code 10 in FIG. 4(c) (waveform obtained in the case that the value of the inductor 23 is L0=0.6 μH), it is understood that the switching frequency is reduced to about an half in the case of making the value of the inductor 23 two times large.

At a peak area where through-rate of the input signal (waveform indicated by a code 9 of FIG. 5(a)) is large, through-rate of the switching electric current Im (waveform indicated by a code 13 in FIG. 5(b)) is lower than one of the input signal. As a result, it is necessary to supply a large electric current (waveform indicated by a code 14 in FIG. 5(b)) at the peak area from the linear amplification unit 3 in order to reproduce the input signal waveform.

On the other hand, at an area where the input signal is small, since the value of the inductor 23 is large, the switching electric current Im (waveform indicated by the code 13 in FIG. 5(b)) due to the previous on-state remains even when switching is turned off. As a result, it is necessary that the linear amplification unit 3 collects a large electric current (waveform indicated by the code 14 in FIG. 5(b)) in order to reproduce the input signal waveform.

As mentioned above, since the large electric current flows actually through the linear amplification unit 3 having low power-efficiency at a time when a broadband signal such as WCDMA is inputted, efficiency of a whole of the power supplying apparatus is degraded. A problem that also efficiency of a whole of the transmitter equipped with the electric power amplifier according to the ET method which uses the power supplying apparatus is degraded is caused as a result.

An object of the present invention is to provide a power supplying apparatus and a control method which are superior in electric power efficiency.

Means to Solve the Problem

A power supplying apparatus according to the present invention includes a switching amplification unit supplying a first load with most of electric power, and a linear amplification unit correcting an output voltage applied to the first load according to an input signal. Furthermore, an electric current which flows into the linear amplification unit at the time of the correcting is supplied to a second load from a power supply terminal of the linear amplification unit.

Moreover, a power supplying apparatus according to the present invention, generating an output voltage according to an input signal, includes a linear amplification unit carrying out correction so as to make a relation between the input signal and the output signal linear, a control signal generating unit generating a control signal based on a flowing direction and a magnitude of an output current of the linear amplification unit, and a switching amplification unit outputting an electric current switching-amplified on the basis of the control signal. Furthermore, the linear amplification unit and the switching amplification unit are arranged in parallel, a total electric current of the output electric current of the linear amplification unit and an output electric current of the switching amplification unit are added and outputted to a first load, and an electric current which flows into the linear amplification unit at the time of the correcting is supplied to a second load from a power supply terminal of the linear amplification unit.

Moreover, a power supplying apparatus according to the present invention, generating an output voltage according to an input signal, includes a linear amplification unit carrying out correction so as to make a relation between the input signal and the output signal linear, a control signal generating unit generating a control signal based on the input signal, and a switching amplification unit outputting a voltage switching-amplified on the basis of the control signal. Furthermore, the linear amplification unit and the switching amplification unit are arranged in series, a total output voltage of an output voltage of the linear amplification unit and an output voltage of the switching amplification unit are added and outputted to a first load, and an electric current which flows into the linear amplification unit at the time of the correcting is supplied to a second load from a power supply terminal of the linear amplification unit.

Moreover, a control method according to the present invention which controls a power supplying apparatus including a switching amplification unit and a linear amplification unit includes supplying a first load with most of electric power by use of the switching amplification unit, and correcting an output voltage applied to the first load according to an input signal by use of the linear amplification unit, and supplying an electric current which flows into the linear amplification unit at the time of the correcting to a second load from a power supplying terminal of the linear amplification unit.

### Effect of the invention

According to the present invention, it is possible to improve electric power efficiency.

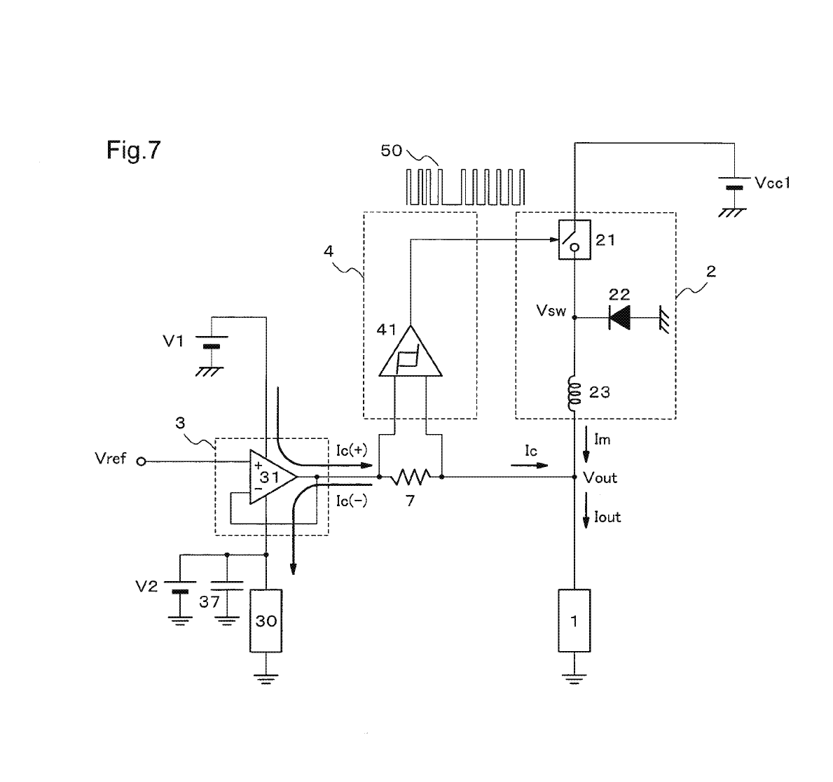

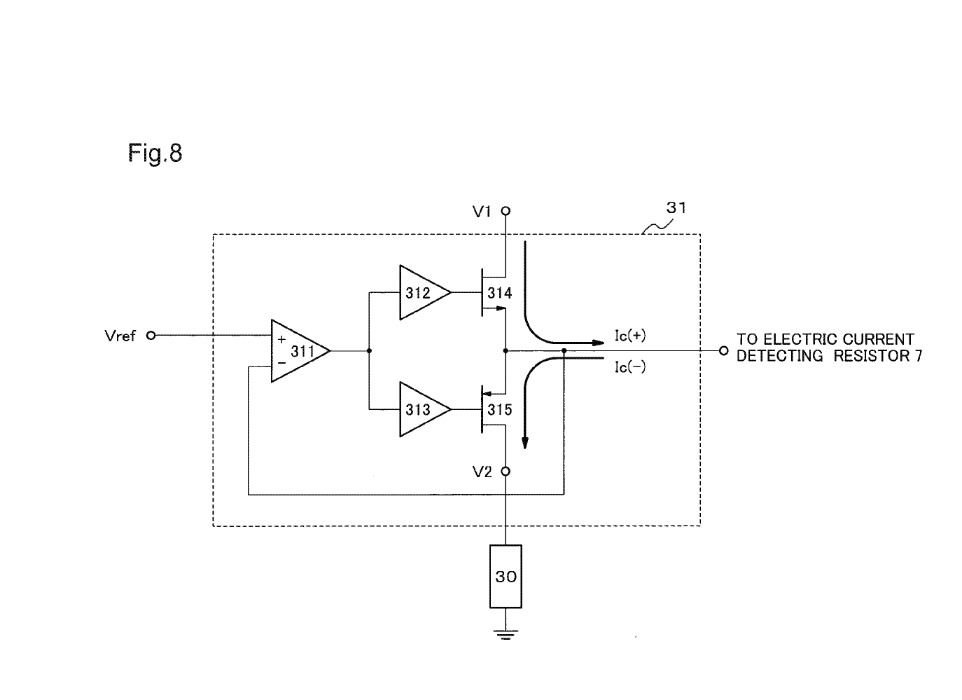

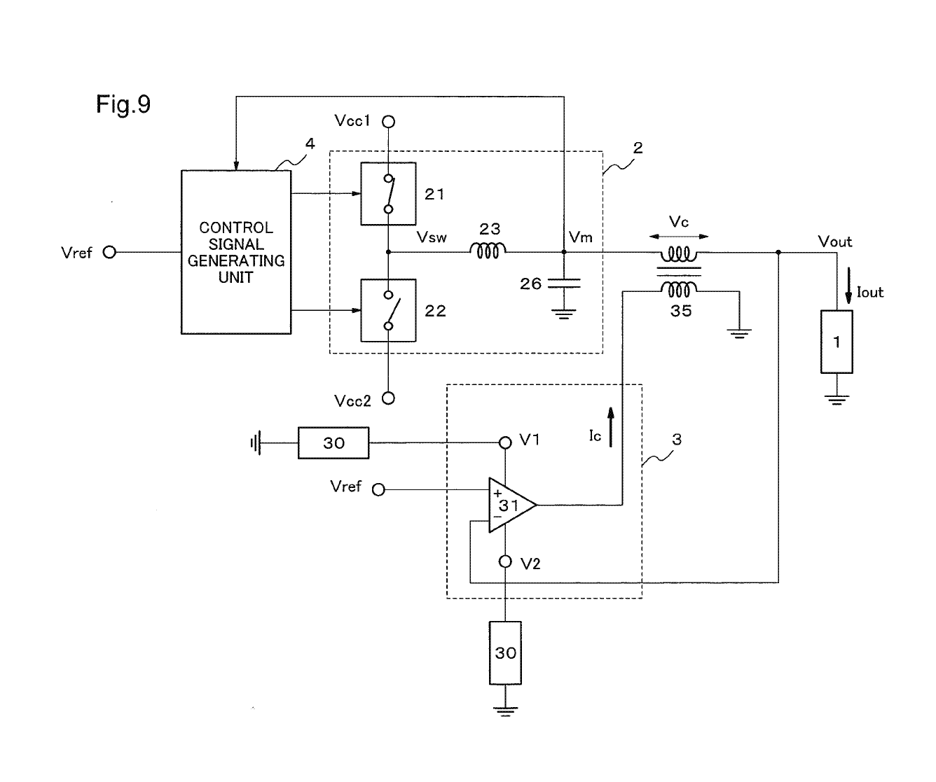

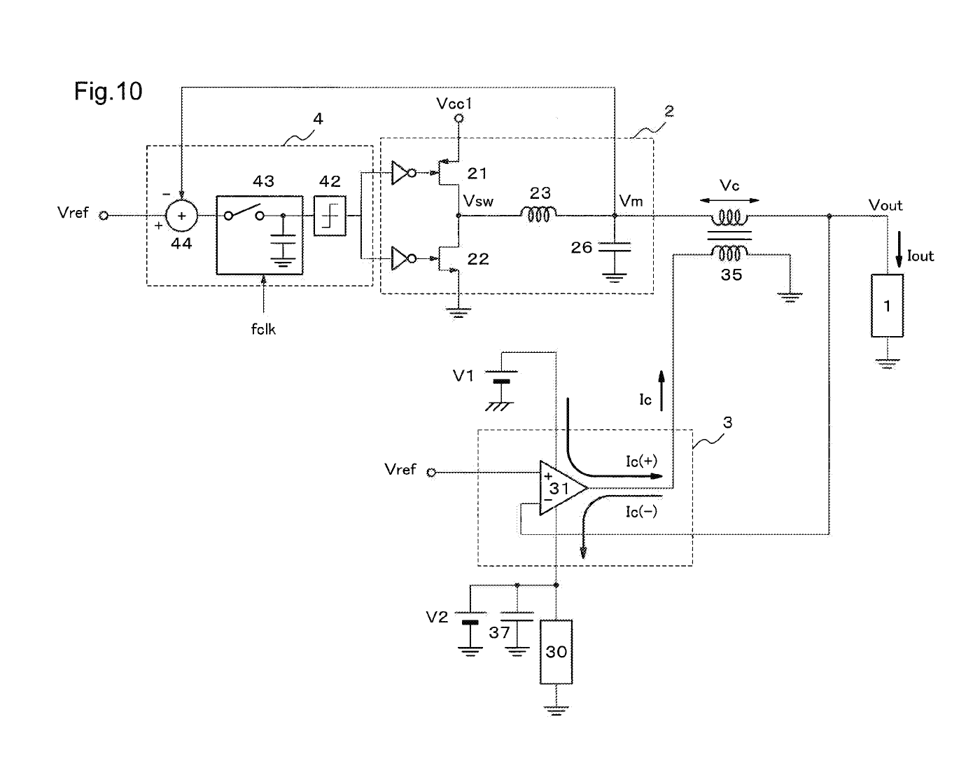

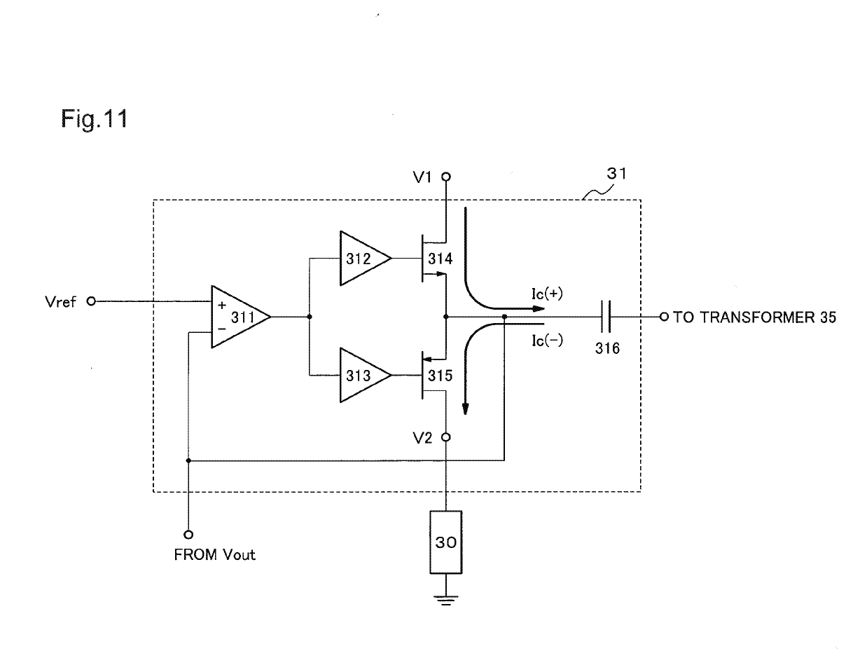

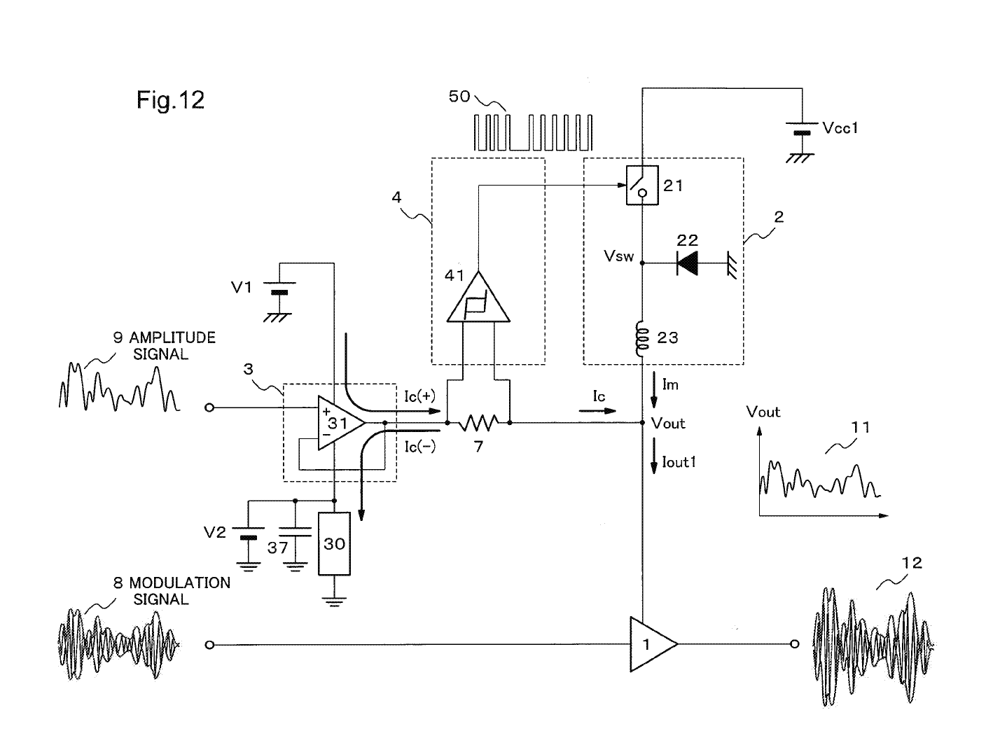

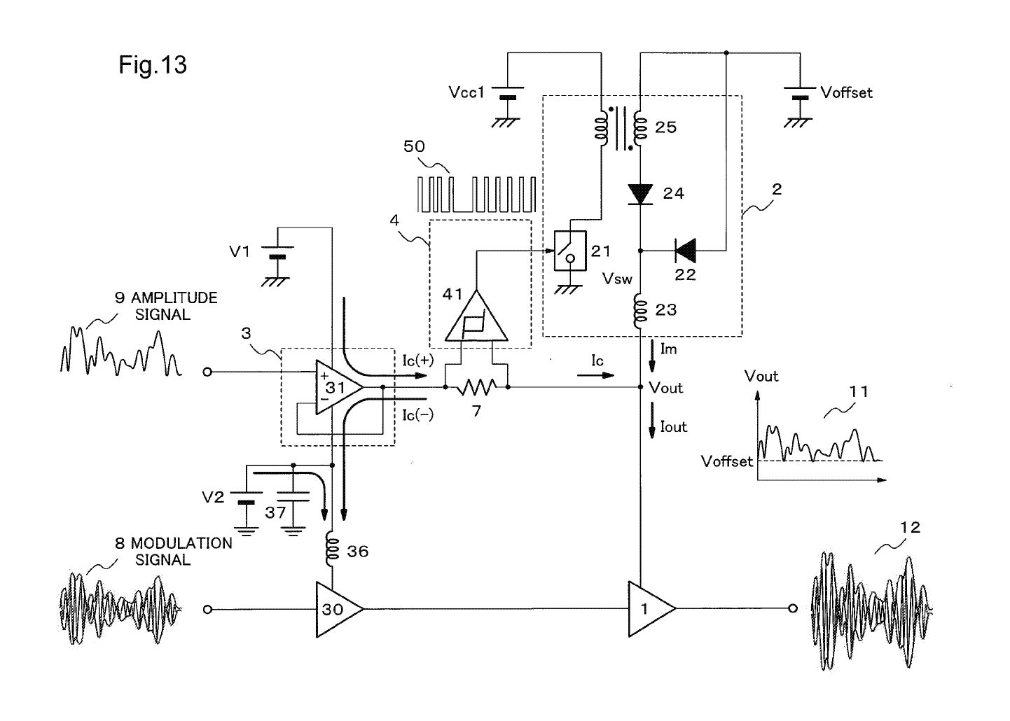

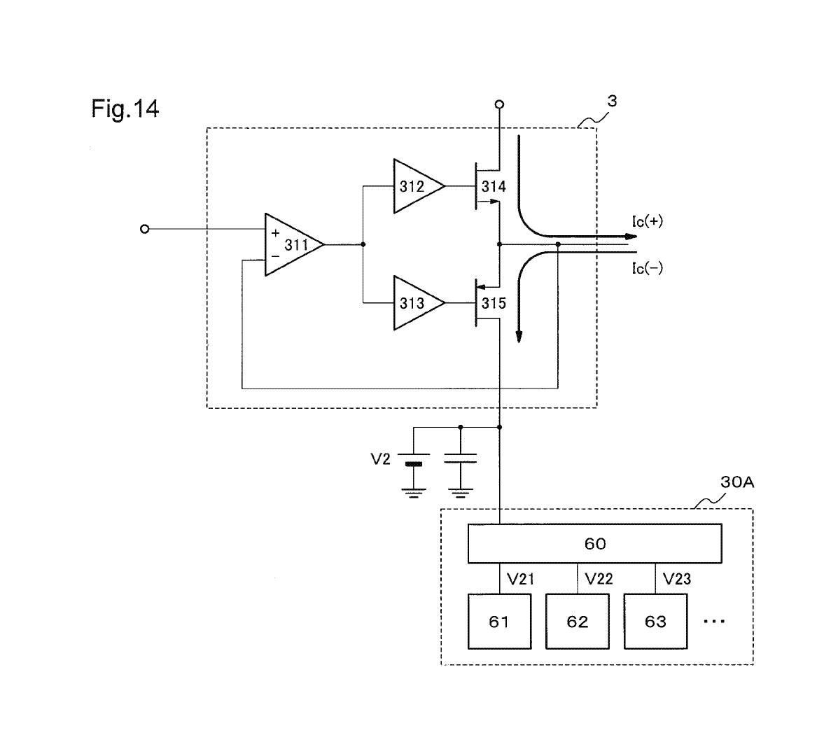

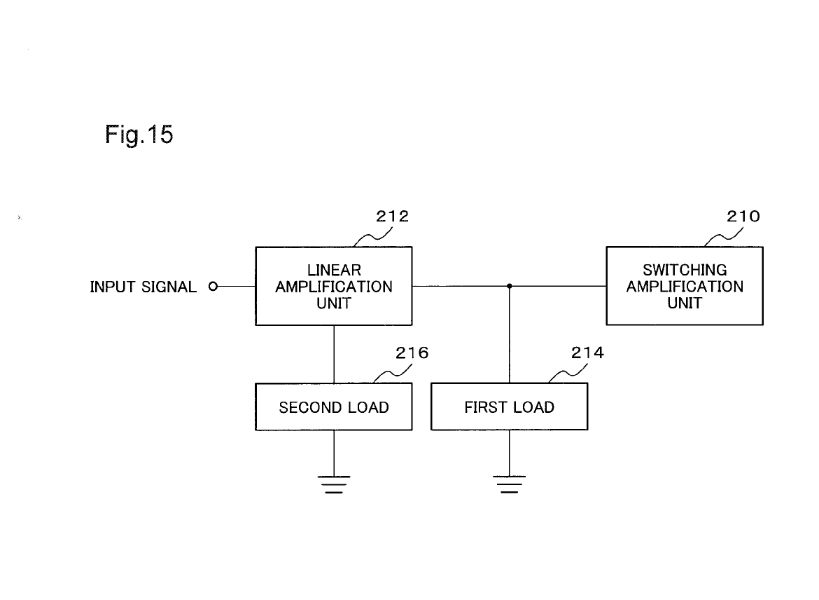

### BRIEF DESCRIPTION OF THE DRAWINGS

[FIG. 1] is a block diagram of a first hybrid voltage source described in a non-patent literature 1.

[FIG. 2] is a block diagram of a second hybrid voltage source described in the non-patent literature 1.

[FIG. 3] is a block diagram of an amplifier (transmitter) in which a configuration of the first hybrid voltage source shown in FIG. 1 is applied to a power supplying apparatus according to the ET method.

[FIG. 4] is a waveform diagram for explaining a specific operation of the amplifier according to the ET method shown in FIG. 3.

[FIG. 5] is another waveform diagram for explaining a specific operation of the amplifier according to the ET method shown in FIG. 3.

[FIG. 6] is a block diagram showing an example of a configuration of a power supplying apparatus according to a first exemplary embodiment of the present invention.

[FIG. 7] is a block diagram showing a specific example of a configuration of each block of the power supplying apparatus shown in FIG. 6.

[FIG. 8] is a block diagram showing a specific example of a configuration of an operational amplifier included in the linear amplification unit shown in FIG. 7.

[FIG. 9] is a block diagram showing an example of a configuration of a power supplying apparatus according to a second exemplary embodiment of the present invention.

[FIG. 10] is a block diagram showing a specific example of a configuration of each block of the power supplying apparatus shown in FIG. 9.

[FIG. 11] is a specific example of a configuration of an operational amplifier included in the linear amplification unit shown in FIG. 10.

[FIG. 12] is a block diagram showing an example of a configuration of a transmitter according to a third exemplary embodiment of the present invention.

[FIG. 13] is a block diagram showing an example of a configuration of a transmitter according to a fourth exemplary embodiment of the present invention.

[FIG. 14] is a block diagram showing an example of a configuration of a power supplying apparatus according to a fifth exemplary embodiment of the present invention.

[FIG. 15] is a block diagram showing an example of a configuration of a power supplying apparatus according to a sixth exemplary embodiment of the present invention.

### BEST MODE FOR CARRYING OUT THE INVENTION

### First Exemplary Embodiment

FIG. 6 is a block diagram showing an example of a configuration of a power supplying apparatus according to a first exemplary embodiment of the present invention. The power supplying apparatus includes, at least, the first load 1, the switching amplification unit 2, the linear amplification unit 3 and the control signal generating unit 4.

The switching amplification unit 2 works as a current source and supplies an electric current to the first load 1. The linear amplification unit 3 works as a voltage source and corrects so that an output voltage applied to the first load 1 may be identical with an input signal. The switching amplification unit 2 and the linear amplification unit 3 are connected each other in parallel for the first load 1. Electric power is supplied from a power supplying terminal of the linear amplification unit 3 to a second load 30.

The reference signal Vref inputted into the power supplying apparatus is inputted specifically into the linear amplification unit 3, and is amplified linearly. The electric current detecting resistor 7 detects a flowing direction and a magnitude of the output electric current Ic of the linear amplification unit 3, and outputs the detection result to the control signal generating unit 4. The control signal generating unit 4 generates a pulse width modulation signal which has two levels of High and Low based on the detected direction and magnitude of the electric current, and outputs the pulse width modulation signal to the switching amplification unit 2 as a control signal. The switching amplification unit 2 makes the switching elements 21 and 22 carry out an on/off work on the basis of the control signal, and converts an output of the switching elements 21 and 22 into the electric current Im by use of the inductor 23 and outputs the electric current Im. An output terminal of the switching amplification unit 2 and an output terminal of the linear amplification unit 3 are connected each other. The output electric current Im (hereinafter, may be described as switching electric current Im) of the switching amplification unit 2 and the output electric current Ic of the linear amplification unit 3 are added each other and the added electric current is supplied to the first load 1. The second load 30 is connected with power supplies V1 and V2 of the linear amplification unit 3. In this case, the second load 30 is corresponding to another block included in the system.

FIG. 7 is a block diagram showing a specific example of a configuration of each block of the power supplying apparatus shown in FIG. 6. The switching amplification unit 2 includes at least the switching element 21, the diode 22 and the inductor 23. The linear amplification unit 3 includes at least the operational amplifier 31. The control signal generating unit 4 includes at least the hysteresis comparator 41.

Hereinafter, an operation of the first exemplary embodiment of the present invention will be described in detail with reference to FIG. 7.

As shown in FIG. 7, the reference signal Vref corresponding to the input signal is inputted to the operational amplifier 31 composing a voltage follower in the linear amplification unit 3. The output electric current Ic of the operational amplifier 31 is converted into a voltage by the electric current detecting resistor 7, and the voltage is inputted to the hysteresis comparator 41. By selecting the polarity so as to be High when the electric current Ic flows from the operational amplifier 31 toward the load 1 (Ic>0), and to be Low when the electric current flows into the operational amplifier 31 (IC<0), an output of the hysteresis comparator 41 is the pulse width modulation signal 50 according to a strength of the reference signal Vref.

When the output electric current Ic which flows from the linear amplification unit 3 toward the first load 1 increases to be IC(+) and the output electric current Ic is equal to a high voltage side threshold value of the hysteresis comparator 41, or larger than the threshold value, the output of the hysteresis comparator 41 is High. This signal is inputted into a gate of the switching element 21 which is composed of MOSFET etc. to turn the switching element 21 on (conductive state). As a result, an electric current flows from the power supply Vcc1 through the switching element 21, and is smoothed by the inductor 23. Afterward, the smoothed electric current flows in a direction toward the first load 1 as the electric current Im. At this time, since the switching voltage Vsw is equal to Vcc1, a reverse voltage is applied to the diode 22, and consequently an electric current does not flow.

At a terminal for the output voltage Vout of the power supplying apparatus shown in FIG. 7, the following formula is satisfied.

Ic=Iout−Im

Here, in the circuit shown in FIG. 7, the linear amplification unit 3 composes a voltage follower as mentioned above. That is, if neglecting the electric current detecting resistor 7 which has quite a small electric resistance value, Vout is equal to Vref. In the case that the first load 1 is assumed to have an electric resistance value R, the following formula is obtained.

Iout=Vout/R

Accordingly, if Vref is fixed, also a value of Iout is fixed. Meanwhile, since the linear amplification unit 3 (voltage follower) works as a voltage source, Ic can have any value. Accordingly, if the excessive electric current Im flows from the switching amplification unit 2 in comparison with the fixed Tout, the excessive electric current has to be adjusted by Ic since Tout is fixed. Accordingly, when the switching electric current Im is excessive in comparison with the output electric current Tout which flows through the first load 1, the operational amplifier electric current Ic (Ic=Ic(−)) flows reversely and starts flowing in a direction flowing into the operational amplifier 31. When a voltage applied to the electric current detecting resistor 7 by the operational amplifier electric current Ic(−) is smaller than a low voltage side threshold value of the hysteresis comparator 41, the polarity of the hysteresis comparator 41 is reversed, and then the switching element 21 is turned off (non-conductive state). At this time, in order to maintain the electric current which flows through the inductor 23, an electric current flows from GND to the first load 1 through the diode 22. Moreover, the potential of the cathode of the diode 22 (that is, switching voltage Vsw) is 0V. The above-mentioned switching operation is repeated and the switching electric current Im is supplied from Vcc1 or from GND alternately to the first load 1. The linear amplification unit (voltage follower) 3 makes the output voltage Vout of the power supplying apparatus identical with the reference signal Vref (or, output voltage Vout is scaled linearly).

Meanwhile, the second load 30 (for example, another block included in the system) is connected with the negative side power supply V2 of the operational amplifier 31, and the operational amplifier electric current Ic(−) is used as a part of an electric current supplied to the second load 30. In this case, a capacitor 37 with large capacitance is arranged at a location of the negative side power supply V2 to remove influence due to a temporal fluctuation of Ic(−).

In the case of a general power supplying apparatus which has the hybrid configuration including the switching amplification unit 2 (current source) and the linear amplification unit 3 (voltage source), electric power of V2*IC(−) which the linear amplification unit 3 consumes for correcting the output voltage results in a loss to degrade efficiency of a whole of the system. In contrast, according to the exemplary embodiment, the second load 30, for example, another block included in the system reuses the electric power. As a result, it is possible to achieve high efficiency as a whole of the system.

Here, while the configuration that the second load 30 is connected with the negative side power supply V2 of the linear amplification unit 3 is described in the example shown in FIG. 7, it is also conceivable to have a configuration that the second load 30 is connected with the positive side power supply V1 of the linear amplification unit 3 in consideration of an electric polarity of a block connected with the first load 1, and an electric polarity of a block connected with the second load 30.

FIG. 8 is a block diagram showing a specific example of a configuration of the operational amplifier 31 included in the linear amplification unit shown in FIG. 7. In this configuration, since the operational amplifier 31 handles large electric power, it is also possible that, as shown in FIG.8, the operational amplifier 31 has a hybrid configuration including a small electric power and broadband operational amplifier 311, buffer amplifiers 312 and 313, and an n type transistor 314 and a p type transistor 315 which compose an output-stage source follower push-pull amplifier.

According to the power supplying apparatus shown in FIG. 7, at the output terminal Vout, the following formula is satisfied.

Ic=Iout−Im

First, an operation which is carried out in the case that the electric current Im from the switching amplification unit 2 is short in comparison with the electric current Tout which flows through the first load 1 will be described. In this case, the electric current Ic (Ic=Ic(+)) flows from the n type transistor 314 included in the output-stage source follower push-pull amplifier of the linear amplification unit 3, and flows into the first load 1 as a part of Tout.

Next, an operation carried out in the case that the electric current Im from the switching amplification unit 3 is excessive in comparison with the electric current Tout which flows through the first load 1. The electric current Ic (Ic=Ic(−)) flows into the p type transistor 315 included in the output-stage source follower push-pull amplifier of the linear amplification unit 3, and the electric power of V2*Ic(−) is consumed. The electric current Ic(−) is unnecessary for the first load 1 originally, and results in a loss from a view point of the system. By connecting a power supply of another block included in the system as the second load 30 with the terminal V2, it is possible to reuse the electric current Ic(−) within the system, and to reduce the loss as a whole of the system.

Here, it is assumed that the system is a transmitter whose first load 1 is an electric power amplifier. In the case of a transmitter used in the base station of the cellular phone, an output electric power of the electric power amplifier is so large that V2*Ic(−) may reach to several watts. Then, by connecting a driver amplifier, a transceiver IC, a baseband IC, ADC/DAC or the like which is other than the amplifier included in the transmitter as the first load 30, it is possible to use the electric power which has been discarded as the loss as effective electric power, and to reduce power consumption of a whole of the transmitter. Here, IC used in the above is an abbreviation of Integrated Circuit. ADC is an abbreviation of Analog-to-Digital Converter. DAC is an abbreviation of Digital-to-Analog Converter.

As a summary of the above, the power supplying apparatus according to the first exemplary embodiment includes the switching amplification unit to supply the electric power to the first load 1 with high efficiency, and the linear amplification unit with superior accuracy to correct so that the voltage applied to the first load 1 may change linearly according to the input signal waveform. Furthermore, the power supplying apparatus reuses the power loss caused during correcting the voltage as the power supply of another block in the system. Accordingly, the power supplying apparatus has the function to change the output voltage according to the magnitude of the input signal, and has high efficiency and superior linearity.

Here, while the case that the electric current Ic(−) flows into the V2 side in FIG. 8, it is also possible to have a configuration that the second load 30 is connected with the V1 side in consideration of the electric polarity of the block connected with the first load 1, and the electric polarity of the block connected with the second load 30.

Moreover, in the first exemplary embodiment described above, configurations of the switching amplification unit 2, the linear amplification unit 3 and the control signal generating unit 4 are not limited to the circuit configuration shown in FIG. 7 (also FIG. 8 with respect to the linear amplification unit 3).

### Second Exemplary Embodiment

FIG. 9 is a block diagram showing an example of a configuration of a power supplying apparatus according to a second exemplary embodiment of the present invention. The power supplying apparatus includes, at least, the first load 1, the switching amplification unit 2, the linear amplification unit 3 and the control signal generating section 4.

The switching amplification unit 2 works as a voltage source and supplies a voltage to the first load 1. The linear amplification unit 3 works as a voltage source, and corrects an output voltage applied to the first load 1 so that it may be identical with an input voltage. The switching amplification unit 2 and the linear amplification unit 3 are connected in series for the first load 1. Electric power is supplied from a power supplying terminal of the linear amplification unit 3 to the second load 30.

The control signal generating unit 4 generates a pulse width modulation signal which has two levels of High and Low based on the reference signal Vref inputted into the power supplying apparatus, and the output voltage Vm, and outputs the pulse width modulation signal to the switching amplification unit 2 as a control signal. The switching amplification unit 2 makes the switching elements 21 and 22 carry out an on/off work on the basis of the control signal. The output voltage Vsw is converted to the voltage Vm by being smoothed by a low pass filter including the inductor 23 and a capacitor 26. The linear amplification unit 3 compares the reference signal Vref and the voltage Vout applied to the first load 1, and outputs a differential voltage Vc. The differential voltage Vc is added with the voltage Vm (hereinafter, voltage Vm may be described as switching voltage Vm) of the switching amplification unit 2 by the transformer 35, and the added voltage is supplied to the first load 1. The second load 30 is connected with the power supplies V1 and V2 of the linear amplification unit 3. In this case, the second load 30 is corresponding to another block included in the system.

FIG. 10 is a block diagram showing an specific example of a configuration of each block of the power supplying apparatus shown in FIG. 9. The switching amplification unit 2 includes, at least, the switching MOSFETs 21 and 22, the inductor 23 and the capacitor 26. The linear amplification unit 3 includes, at least, the operational amplifier 31. The control signal generating unit 4 includes, at least, a comparator 42, a sample-hold circuit 43 and a subtractor 44.

Hereinafter, an operation according to the second exemplary embodiment of the present invention will be described in detail with reference to FIG. 10.

As shown in FIG. 10, the reference signal Vref corresponding to the input signal is inputted to the subtractor 44 of the control signal generating unit 4. The subtractor 44 outputs a difference between the reference signal Vref and the output Vm of the switching amplification unit 2. The sample-hold circuit 43 samples the differential signal with a clock frequency fclk. The sampled differential signal is inputted to the comparator 42. The comparator 42 judges a polarity of the sampled differential signal and outputs a control signal which is High if the differential signal has a positive polarity and is Low if having a negative polarity to the switching amplification unit 2. The control signal obtained by carrying out the above-mentioned operation has a large possibility of being High when the reference signal Vref is increased and has a large possibility to be Low when the reference signal Vref is decreased. That is, the control signal is identical with the delta modulation signal.

The switching amplification unit 2 has an inverter configuration including the p type switching MOSFET 21, and the n type switching MOSFET 22, and reverses the control signal provided by the control signal generating section 4 and inputs the reversed control signal into the switching MOSFETs 21 and 22. When the control signal is High, the switching MOSFET 21 is turned on (conductive state), and the switching MOSFET 22 is turned off (non-conductive state), and an electric current flows from Vcc1, and the electric current is outputted in a direction toward the first load 1 through the inductor 23. At this time, the output voltage Vsw is corresponding to Vcc1. On the other hand, when the control signal is Low, the switching MOSFET 21 is turned off (non-conductive state), and the switching MOSFET 22 is turned on (conductive state). Then, in order to maintain an electric current which flows through the inductor 23, a current flows from GND in a direction toward the first load 1. At this time, the output voltage Vsw is 0. The pulse-shaped output voltage Vsw obtained by carrying out the above-mentioned operation is smoothed by the low pass filter including the inductor 23 and the capacitor 26, and the smoothed output voltage Vsw is outputted as the voltage Vm. Moreover, since the switching amplification unit 2 does not consume any electric power in an ideal state, it is possible to supply the voltage Vm to the load with high power-efficiency. In the case that the clock frequency fclk of the sample-hold circuit 43 is high sufficiently, the output voltage Vm of the switching amplification unit 2 obtained by carrying out the above-mentioned operation is approximately equal to the reference signal Vref. However, in the case that the clock frequency fclk is too high, a switching rate of the switching amplification unit 2 also is high, and power loss caused by the parasitic capacitors of the switching MOSFETs 21 and 22 is large. That is, since it is impossible to make fclk high too much in order to maintain high power-efficiency, the output voltage Vm includes residual switching noise, and consequently the output voltage Vm is not identical with the reference signal Vref.

In the linear amplification unit 3, the reference signal Vref is inputted into the operational amplifier 31 which composes a feed back amplifier, and the voltage Vout applied to the load 1 is fed back to the operational amplifier 31, and then the operational amplifier 31 outputs the differential voltage Vc. The differential voltage Vc is inputted into a first side coil of the transformer 35 whose second side coil is connected with the output of the switching amplification unit 2. At this time, the linear amplification unit 3 works so as to amplify only an AC component and so as to make a DC current not flow through the transformer 35. Hereinafter, a reason why only the AC component is amplified will be described. For example, the operational amplifier 31 of the linear amplification unit 3 shown in FIG. 10 has a configuration which is shown, for example, in FIG. 11 (description on FIG. 11 will be made later). The DC current does not flow through the transformer 35 by a capacitor 316. While the operational amplifier 31 adjusts the output voltage so that Vout may be equal to Vref, only the AC component is outputted (amplifying) by the capacitor 316. While Vref and Vout include DC components respectively, only the AC component is outputted into the transformer 35. As a result, “only AC component” is amplified. It is assumed that a ratio of winding number of the first side coil to winding number of the second side coil of the transformer 35 is set to “1:1”. Then, the output voltage Vm of the switching amplification unit 2 and the differential voltage Vc are added to be outputted to the first load 1 as Vout. The output voltage Vout of the power supplying apparatus obtained by carrying out the above-mentioned operation will be identical with the reference signal Vref (or, Vout is scaled linearly) with superior accuracy.

The second load 30 (for example, another block included in the system) is connected with the negative side power supply V2 of the operational amplifier 31, and Ic(−) is used as a part of the electric current supplied to the second load 30. At this time, a capacitor 37 with large capacitance is arranged at a location of the negative side power supply V2 to remove influence due to a temporal fluctuation of Ic(−).

In the case of a general power supplying apparatus which has the hybrid configuration including the switching amplification unit 2 (voltage source) and the linear amplification unit 3 (voltage source), electric power of IC(−)*V2 which the linear amplification unit 3 consumes for correcting the output voltage results in a loss to degrade efficiency of a whole of the system. In contrast, according to the exemplary embodiment, by the second load 30 (for example, another block included in the system) reusing the electric power, it is possible to achieve high efficiency of a whole of the system.

Here, while the configuration that the second load 30 is connected with the negative side power supply V2 of the linear amplification unit 3 is described in the example shown in FIG. 10, it is also conceivable to have a configuration that the second load 30 is connected with the positive side power supply V1 of the linear amplification unit 3 in consideration of an electric polarity of a block connected with the first load 1, and an electric polarity of a block connected with the second load 30.

FIG. 11 is a block diagram showing a specific example of a configuration of the operational amplifier 31 included in the linear amplification unit 3 shown in FIG. 10. In the example of the configuration, since the operational amplifier 31 handles large electric power, it is also possible that, as shown in FIG. 11, the operational amplifier 31 has a hybrid configuration including the small electric power and broadband operational amplifier 311, the buffer amplifiers 312 and 313, and the n type transistor 314 and the p type transistor 315 which compose the output-stage source follower push-pull amplifier. As understood from FIG. 11, since Ic(−) flows through the capacitor 316, Ic(−) includes only the AC component. Moreover, an electric current which flows through the capacitor 37 with large capacitance is a displacement current i which is equal to dQ/dt=C*dV/dt (Q means an electric charge saved on the capacitor). In the case of FIG. 10, since a voltage between both ends of the capacitor 37 is fixed to the power supply voltage V2 and does not change (that is, dV/dt=0), the displacement current i does not flow and then all of Ic(−) flows into the second load 30. Here, while it is difficult actually to judge whether Ic(−) flows into the power supply V2 or into the second load 30, Ic(−) flows into the second load 30 from a macroscopic view point. As a result, it is possible to use an expression that “Ic(−) is used as a part of the electric current supplied to the second load 30.”

Here, as mentioned above, in the case that electric potential of the power supply V2 is fixed to an ideal value, it is not essential to arrange the capacitor 37 for stabilizing the voltage. The reason why the capacitor 37 with large capacitance is required is that, in the case that there is a possibility that potential applied to the second load 30 fluctuates due to influence caused by a parasitic electric resistance or the like, it is necessary to suppress potential fluctuation ΔV (ΔV=ΔQ/C≈0) by using the capacitor with large capacitance. In this case, while the displacement current flows, a change component ΔQ of the charge saved in the capacitor 37 is switched with the power supply V2 or is supplied to the second load 30. Accordingly, the electric charge charged by Ic(−) does is not useless, and the effect of the present invention is maintained. In other words, the displacement current flows through the capacitor 37, but energy of Ic(−) is not consumed by the capacitor 37 and is consumed minutely by the parasitic electric resistance. Accordingly, it is conceivable that almost all energy is reused by the second load 30.

At an output terminal Vout of the power supplying apparatus shown in FIG. 10, the following formula is satisfied.

Vc=Vout−Vm

While the switching amplification unit 2 carries out the high-efficient switching amplification so that the output voltage Vm may be near to the output voltage Vout of a whole of the power supplying apparatus, Vout is generally not identical to Vm. The linear amplification unit 3 has a feed back loop so that the output Vout of the power supplying apparatus and the reference signal Vref may be identical (or Vout is scaled linearly). Accordingly, in the case that the voltage Vm supplied by the switching amplification unit 2 is low in comparison with Vout which should be applied to the first load 1 (Vm<Vout), the electric current Ic (Ic=Ic(+)) flows from the n type transistor 314 included in the output-stage source follower push-pull amplifier of the linear amplification unit 3, and the voltage Vc (Vc=Vout−Vm(>0)) is generated in the first side of the transformer 35. The voltage Vc is transferred to the second side of the transformer 35, and then the transferred Vc, and Vm are added so that the desired output voltage Vout is generated. On the other hand, in the case that the voltage Vm supplied by the switching amplification unit 2 is high in comparison with Vout applied to the first load 1 (Vm>Vout), the electric current Ic (Ic=Ic(−)) flows into the p type transistor 315 included in the output-stage source follower push-pull amplifier of the linear amplification unit 3, and the voltage Vc (Vc=Vout−Vm(<0)) is generated in the first side of the transformer 35. The voltage Vc is transferred to the second side of the transformer 35, and then the transferred Vc, and Vm are added so that the desired output voltage Vout is generated. The electric current Ic(−) is unnecessary for the first load 1 originally, and results in a loss from a view point of a whole of the system. By connecting a power supply of the second load 30 (for example, another block included in the system) with a terminal V2, it is possible to reuse the electric current Ic(−) within the system, and to reduce the loss as a whole of the system.

Here, it is assumed that a transmitter, whose first load 1 is a power amplifier. In the case of a transmitter used in the base stations of the cellular phone, an output power of the power amplifier is so large that V2*Ic(−) may reach to several watts in some cases. Then, by connecting a driver amplifier, a transceiver IC, a baseband IC, ADC/DAC or the like which is other than the amplifier and which is included in the transmitter as the second load 30 with the terminal V2, it is possible to use the electric power which has been discarded as the loss as an effective electric power, and to reduce power consumption of a whole of the transmitter.

As a summary of the above, the power supplying apparatus according to the second exemplary embodiment includes the switching amplification unit to supply the electric power to the first load 1 with high efficiency, and the linear amplification unit with superior accuracy to correct so that the voltage applied to the first load 1 may change linearly according to the input signal waveform. Furthermore, the power supplying apparatus reuses the power loss caused during correcting the voltage as the power supply of another block in the system. Accordingly, the power supplying apparatus has the function to change the output voltage according to the magnitude of the input signal, and has high efficiency and superior linearity.

Here, while the case that the electric current Ic(−) flows into the V2 side in FIG. 11, it is also possible to have a configuration that the second load 30 is connected with the V1 side in consideration of an electric polarity of a block connected with the first load 1, and an electric polarity of a block connected with the second load 30.

Moreover, while, in the example of FIG. 10, the control signal generating unit 4 is described by exemplifying the delta modulation, the pulse width modulation and the delta sigma modulation are also applicable instead of the delta modulation.

Moreover, in the second exemplary embodiment described above, configurations of the switching amplification unit 2, the linear amplification unit 3 and the control signal generating unit 4 are not limited to the circuit configuration shown in FIG. 10 (also FIG. 11 with respect to the linear amplification unit 3).

### Third Exemplary Embodiment

FIG. 12 is a block diagram showing an example of a configuration of a transmitter according to a third exemplary embodiment of the present invention. The transmitter is a transmitter which uses the power supplying apparatus according to the first exemplary embodiment (specifically, the power supplying apparatus described in FIG. 7).

Since a configuration and an operation principle of a power supplying apparatus are the same as ones described by use of FIG. 6 and FIG. 7 in the first exemplary embodiment, description on the configuration and the operation principle is omitted. Hereinafter, a configuration and an operation of the transmitter will be described.

According to the transmitter of the exemplary embodiment, an electric power amplifier is connected as the first load 1 connected to the power supplying apparatus. The amplitude signal 9 of the input modulation signal 8 is inputted to the power supplying apparatus as the reference signal Vref. A waveform of the inputted amplitude signal 9 is amplified linearly and the amplified amplitude signal 9 is outputted as the output voltage Vout (waveform indicated by a code 11 in FIG. 12) according to the operation principle of the power supplying apparatus described in FIG. 7. The output voltage Vout is used as a power supply voltage of the electric power amplifier. The electric power amplifier which uses the output voltage Vout of the power supplying apparatus as the own power supply carries out the linear amplification such as the class A, the class AB or the like in the case of the ET method, or carries out the switching mode amplification such as the class E, the class F, the class D or the like in the case of the EER method. Then, the electric power amplifier outputs a high frequency modulation signal 12 with which amplitude and phase were modulated.

The second load 30 (for example, another block included in the transmitter) is connected to the negative side power supply V2 of the linear amplification unit 3 included in the power supplying apparatus. And, Ic(−) is used as a part of the electric current supplied to the second load 30. At this time, the capacitor 37 with large capacitance is arranged at a location of the negative side power supply V2 of the linear amplification unit 3 to remove influence due to a temporal fluctuation of Ic(−).

By carrying out the operation mentioned above, the power supplying apparatus supplies the first load 1 (for example, the electric power amplifier) with necessary and minimum electric power according to the amplitude of the inputted modulation signal 8. As a result, since useless electric power is not generated in comparison with a case that the power supplying apparatus supplies a constant voltage, it is possible to operate with high power-efficiency. Moreover, since the second load 30 (for example, another block included in the transmitter) uses useless electric power caused at a time when the power supplying apparatus generates the modulation voltage Vout, it is possible to realize quite high power-efficiency as a whole of the transmitter.

As another block included in the transmitter, a driver amplifier, a transceiver IC, a baseband IC, ADC/DAC or the like is exemplified. Since electric power consumption of the electric power amplifier is quite large in general in comparison with power consumption of another block included in the transmitter, even electric power which has the same order of magnitude of the electric power consumption for correcting an error of the output voltage Vout in the power supplying apparatus can be a power supply sufficiently effective for another block.

Moreover, while the transmitter shown in FIG. 12 uses the power supplying apparatus according to the first exemplary embodiment (power supplying apparatus in which the switching amplification unit which works as the current source, and the linear amplification unit which works as the voltage source are connected in parallel) as the power supplying apparatus, the present invention is not limited to the above-mentioned power supplying apparatus. For example, the transmitter can use the power supplying apparatus according to the second exemplary embodiment (power supplying apparatus in which the switching amplification unit which works as the voltage source, and the linear amplification unit which works as the voltage source are connected in series).

### Fourth Exemplary Embodiment

FIG. 13 is a block diagram showing an example of a configuration of a transmitter according to a fourth exemplary embodiment of the present invention. The transmitter is a transmitter which uses the power supplying apparatus according to the first exemplary embodiment (specifically, the power supplying apparatus described in FIG. 7).

A case that “electric power amplifier” is connected as the first load 1 connected with the power supplying apparatus, and “driver amplifier” of the electric power amplifier is connected as the second load 30 in the transmitter of the exemplary embodiment is exemplified.

A configuration and an operation principle of the power supplying apparatus are almost the same as ones described by use of FIG. 6 and FIG. 7 in the first exemplary embodiment. A different point is a configuration and an operation of the switching amplification unit 2. When the output electric current Ic (Ic=Ic(+)) of the linear amplification unit 3 increases and the voltage applied to the electric current detecting resistor 7 is equal to a high voltage side threshold value of the hysteresis comparator 41, or larger than the threshold value, an output of the hysteresis comparator 41 is High. This signal is inputted into a gate of the switching element 21 which is composed of MOSFET etc. to turn the switching element 21 on (conductive state). One terminal of the switching element 21 is grounded, and the other terminal is connected with the power supply Vcc1 through a first side coil of a transformer 25. An electric current flows from the power supply Vcc1 to the first side of the transformer 25 through the switching element 21, and electric power saved in the first coil is transferred to the second side coil, and an electric current flows from a second side power supply Voffset through a second coil of the transformer 25 and a diode 24. After the electric current is smoothed by the inductor 23, the smoothed current flows in a direction toward the first load 1 as the electric current Im. At this time, in the case that it is assumed that a ratio of winding number of the first side coil to winding number of the second side coil of the transformer 25 is set to “1:1”, a voltage of Vsw (Vsw=Voffset+Vcc1) is generated at a cathode of the diode 24.

Since the following formula is satisfied at the output terminal Vout of the power supplying apparatus shown in FIG. 13,

Ic=Iout−Im

when the switching electric current Im is excessive in comparison with the output electric current Tout which flows through the first load 1, the output electric current Ic of the linear amplification unit 3 flows reversely (that is, Ic=Ic(−)), and starts flowing in a direction toward the linear amplification unit 3. When the voltage applied to the electric current detecting resistor 7 by the output electric current Ic of the linear amplification unit 3 is smaller than a low voltage side threshold value of the hysteresis comparator 41, a polarity of the hysteresis comparator 41 is reversed, and the switching element 21 is turned off (non-conductive state). At this time, in order to maintain the electric current which flows through the inductor 23, an electric current flows at the second side of the transformer 25 from Voffset to the first load 1 through the diode 22. Then, the electric potential Vsw of the cathode of the diode 22 is Voffset. The above-mentioned switching operation is repeated, and the diode 24 or the diode 22 alternately supplies the electric current Im to the load 1. In the operation of the power supplying apparatus, the positive side power supply voltage V1 and the negative side power supply voltage V2 of the linear amplification unit 3 are shifted typically by an amount of Voffset.

The amplitude signal 9 of the input modulation signal 8 is inputted to the power supplying apparatus as the reference signal Vref. According to the above-mentioned operation principle of the power supplying apparatus, an output voltage is generated by amplifying a waveform of the inputted amplitude signal 9, and the output voltage is shifted by an amount of Voffset and the shifted output voltage is outputted as the output voltage Vout (waveform indicated by a code 11 in FIG. 13). The output voltage Vout is used as a power supply voltage of the electric power amplifier. The electric power amplifier carries out the linear amplification such as the class A, the class B or the like with using the output voltage Vout of the power supplying apparatus as an own power supply, and outputs the high frequency modulation signal 12 with which amplitude and phase were modulated.

A driver amplifier corresponding to the second load 30 is connected to the negative side power supply V2 of the linear amplification unit 3 included in the power supplying apparatus through a choke inductor 36. And, Ic(−) is used as a part of an electric current supplied to the driver amplifier. At this time, the capacitor 37 with large capacitance is arranged at a location of the negative side power supply V2 of the linear amplification unit to remove influence of a temporal fluctuation of Ic(−). The modulation signal 8 is inputted to the driver amplifier, and an output of the driver amplifier is inputted to the electric power amplifier.

By carrying out the above-mentioned operation, the power supplying apparatus supplies the electric power amplifier with only the necessary and minimum electric power according to the amplitude of the inputted modulation signal 8. As a result, since useless electric power is not generated in comparison with a case that the power supplying apparatus supplies a constant voltage, it is possible to operate with high power-efficiency. Moreover, since the second load 30 (for example, a driver amplifier included in the transmitter) uses useless electric power caused at a time when the power supplying apparatus generates the modulation voltage Vout, it is possible to realize quite high power-efficiency as a whole of the transmitter.

Furthermore, according to the transmitter of the exemplary embodiment, since the output voltage is shifted by an amount of the offset voltage Voffset, and also the voltages V1 and V2 of the linear amplification unit 3 can be adjusted according to the offset voltage, design flexibility according to an operational condition of the block connected to the second load 30 is improved. Moreover, it is desirable to set the offset to Vout to some extent from a view point of avoiding influence caused by noise and non-linearity of the power supplying apparatus on the output signal 12 of the electric power amplifier which operates according to the ET method.

Here, while the case that the driver amplifier is connected as the second load 30 is exemplified in FIG. 13, the present invention is not limited to the case. The blocks (for example, a transceiver IC, a baseband IC, ADC/DAC or the like) included in the transmitter may be applicable to the second load 30. Furthermore, since electric power consumption of the first load 1 (for example, electric power amplifier) is quite large in general in comparison with power consumption of the second load 30 (for example, another block included in the transmitter), even electric power which is the same order of magnitude of power consumption for correcting an error of the output voltage Vout in the power supplying apparatus can be a power supply which is sufficiently effective for another block.

Moreover, while the transmitter shown in FIG. 13 uses the power supplying apparatus according to the first exemplary embodiment (power supplying apparatus in which the switching amplification unit which works as the current source, and the linear amplification unit which works as the voltage source are connected in parallel) as the power supplying apparatus, the present invention is not limited to the above-mentioned power supplying apparatus. For example, the transmitter can use the power supplying apparatus according to the second exemplary embodiment (power supplying apparatus in which the switching amplification unit which works as the voltage source, and the linear amplification unit which works as the voltage source are connected in series). In this case, the output of the switching amplification unit which works as the voltage source is added with the offset voltage Voffset, and afterward the added output is connected with the electric power amplifier (first load 1).

### Fifth Exemplary Embodiment

FIG. 14 is a block diagram showing an example of a configuration of a power supplying apparatus according to a fifth exemplary embodiment of the present invention. A feature of the power supplying apparatus is a configuration of a second load 30A connected with the linear amplification unit 3. Accordingly, FIG. 14 shows only the second load 30A (but the linear amplification unit 3 is shown in FIG. 14 since the linear amplification unit 3 is necessary for describing the second load 30A), and description on each component other than the second load 30A is omitted. Moreover, since each component other than the second load 30A and an operation of each the component has been already described in any one of the first to the fourth exemplary embodiments, description on the component and the operation are omitted in the following.

As understood from FIG. 14, the second load 30A is connected with the negative side power supply V2 of the linear amplification unit 3. In the second load 30A, the power supply V2 is inputted to a DC (Direct Current)-DC converter 60 which has a plurality of outputs. The DC-DC converter 60 converts the power supply V2 into a plurality of outputs V21, V22 and V23. A load 61 is connected with the output V21. A load 62 is connected with the output V22. A load 63 is connected with the output V23.

As a case that the configuration is effective in particular, for example, a case that “power amplifier” is connected as the first load 1 as shown in FIG. 12 and FIG. 13, or the like is exemplified. In general, electric power consumption of the electric power amplifier is quite large in comparison with electric power consumption of the second load 30A (for example, another block included in the transmitter). Therefore, even electric power which has the same order of magnitude of power consumption for correcting an error of the output voltage Vout in the power supplying apparatus can be a power supply which is sufficiently effective for driving a plurality of the blocks. Furthermore, a power supply voltage of the electric power amplifier used in the base station or the like, is large sufficiently in comparison with a power supply voltage of another block (for example, a transceiver IC, a baseband IC, ADC/DAC or the like) included in the transmitter. Accordingly, it is effective to convert the power supply V2 into a voltage suitable for each block by use of the DC-DC converter 60 and to supply each block with the converted voltage. For example, in the case that the power supply is used in the base station, V2 may be about 10V in some cases. In this case, by lowering V2 to the voltage suitable for each block such as 1.8V, 3.3V, 5V, and the like which are suitable for V21, V22, V23, and the like respectively, and the lowered voltage is supplied to the respective block.

Here, while the second load 30A is connected with the negative side power supply V2 of the linear amplification unit 3 according to the example shown in FIG. 14, it is also conceivable that the second load 30 is connected with the positive side power supply V1 of the linear amplification unit 3 in consideration of an electric polarity of the first load 1, and an electric polarity of the second load 30A.

Moreover, it is quite apparent that the second load 30A described above is applicable to the second load 30 according to the first to the fourth exemplary embodiments.

### Sixth Exemplary Embodiment

FIG. 15 is a block diagram showing an example of a configuration of a power supplying apparatus according to a sixth exemplary embodiment of the present invention. The power supplying apparatus includes a switching amplification unit 210 to supply main electric power to a first load 214, and a linear amplification unit 212 to correct an output voltage applied to the first load 214 according to the input signal. An electric current which flows into the linear amplification unit 212 at a time of the correcting is supplied to a second load 216 from a power supplying terminal of the linear amplification unit 212.

According to the sixth exemplary embodiment described above, since the linear amplification unit 212 reuses electric power loss (electric power based on an electric current which flows into the linear amplification unit 212 at the time of the correcting) caused at a time when correcting the output voltage as a power supply of the second load 216 (for example, another block included in a system), it is possible to improve electric power efficiency.

Each exemplary embodiment described above can be applied to a terminal or a base station of the cellular phone, the wireless LAN, or WiMAX (Worldwide Interoperability for Microwave Access) or can be applied to a transmitter of the terrestrial digital broadcasting office.

While the present invention has been described with reference to the exemplary embodiment, the invention of the present application is not limited to the above-mentioned exemplary embodiment. Various changes which a person skilled in the art can understand can be added to the composition and the detail of the present invention in the scope of the present invention.

This application is based upon and claims the benefit of priority from Japanese Patent Application No. 2011-046502 filed on Mar. 3, 2011, the disclosure of which is incorporated herein in its entirety by reference.

A part of or a whole of the exemplary embodiment mentioned above can be described as the following supplementary notes, but the present invention is not limited to the following supplementary notes.
(Supplementary note 1) A power supplying apparatus, comprising: a switching amplification unit supplying a first load with most of electric power; and a linear amplification unit correcting an output voltage applied to the first load according to an input signal, wherein an electric current which flows into the linear amplification unit at the time of the correcting is supplied to a second load from a power supply terminal of the linear amplification unit.
(Supplementary note 2) A power supplying apparatus generating an output voltage according to an input signal, comprising: a linear amplification unit carrying out correction so as to make a relation between the input signal and the output signal linear; a control signal generating unit generating a control signal based on a flowing direction and a magnitude of an output electric current of the linear amplification unit; and a switching amplification unit outputting an electric current switching-amplified on the basis of the control signal, wherein the linear amplification unit and the switching amplification unit are arranged in parallel, a total electric current of the output electric current of the linear amplification unit and an output electric current of the switching amplification unit are added and outputted to a first load, and an electric current which flows into the linear amplification unit at the time of the correcting is supplied to a second load from a power supply terminal of the linear amplification unit.
(Supplementary note 3) The power supplying apparatus according to supplementary note 2, wherein the flowing direction and the magnitude of the output electric current of the linear amplification unit are found by detecting a potential drop caused by an electric resistance element arranged in series to an output path of the linear amplification unit.
(Supplementary note 4) The power supplying apparatus according to supplementary note 2 or 3, wherein the control signal generating unit includes at least one hysteresis comparator and outputs a judging result based on the flowing direction and the magnitude of the output electric current of the linear amplification unit as the control signal.
(Supplementary note 5) A power supplying apparatus generating an output voltage according to an input signal, comprising: a linear amplification unit carrying out correction so as to make a relation between the input signal and the output signal linear; a control signal generating unit generating a control signal based on the input signal; and a switching amplification unit outputting a voltage switching-amplified on the basis of the control signal, wherein the linear amplification unit and the switching amplification unit are arranged in series, a total output voltage of an output voltage of the linear amplification unit and an output voltage of the switching amplification unit are added and outputted to a first load, and an electric current which flows into the linear amplification unit at the time of the correcting is supplied to a second load from a power supply terminal of the linear amplification unit.
(Supplementary note 6) The power supplying apparatus according to supplementary note 5, wherein the control signal generating unit has a configuration based on any one of the delta modulation, the pulse width modulation and the delta sigma modulation.
(Supplementary note 7) The power supplying apparatus according to any one of supplementary notes 1 to 6, wherein the linear amplification unit is a voltage follower or a negative feedback amplifier, and a feed back signal is obtained from an output terminal.
(Supplementary note 8) The power supplying apparatus according to any one of supplementary notes 1 to 7, wherein the second load includes a plurality of blocks connected in parallel each other, and converts a power supply voltage of the linear amplification unit into a voltage corresponding to each of the plural blocks and connects the voltage to the corresponding block.
(Supplementary note 9) A transmitter which amplifies an input modulation signal including an amplitude modulation component and a phase modulation component, and outputs the amplified input modulation signal, comprising: the power supplying apparatus according to any one of supplementary notes 1 to 8; an electric power amplifier connected as a first load of the power supplying apparatus; and a configuration block connected as a second load, wherein an amplitude modulation component of the input modulation signal is inputted into the power supplying apparatus, and the electric power amplifier works with using an output signal of the power supplying amplifier as a power supply, and amplifies the input modulation signal, and outputs the amplified input modulation signal.
(Supplementary note 10) A transmitter which amplifies an input modulation signal including an amplitude modulation component and a phase modulation component, and outputs the amplified input modulation signal, comprising: the power supplying apparatus according to any one of supplementary notes 1 to 8; an electric power amplifier connected as a first load of the power supplying apparatus; and a configuration block connected as a second load, wherein an amplitude modulation component of the input modulation signal is inputted into the power supplying apparatus, and the electric power amplifier works with using an output signal of the power supplying amplifier as a power supply, and amplifies the phase component of the input modulation signal, and outputs the amplified phase component.
(Supplementary note 11) A control method of a power supplying apparatus which includes a switching amplification unit and a linear amplification unit, comprising: supplying a first load with most of electric power by use of the switching amplification unit; correcting an output voltage applied to the first load according to an input signal by use of the linear amplification unit; and supplying a second load with an electric current which flows into the linear amplification unit at the time of the correcting to a second load from a power supplying terminal of the linear amplification unit.

What is claimed is:

1. to 10. (canceled)

11. A power supplying apparatus, comprising:
a switching amplification unit which supplies a first load with most of electric power; and
a linear amplification unit which corrects an output voltage applied to the first load according to an input signal, wherein
an electric current which flows into the linear amplification unit at the time of the correcting is supplied to a second load from a power supply terminal of the linear amplification unit.

12. A power supplying apparatus generating an output voltage according to an input signal, comprising:
a linear amplification unit which carries out correction so as to make a relation between the input signal and the output signal linear;
a control signal generating unit which generates a control signal based on a flowing direction and a magnitude of an output electric current of the linear amplification unit; and
a switching amplification unit which outputs an electric current switching-amplified on the basis of the control signal, wherein
the linear amplification unit and the switching amplification unit are arranged in parallel, a total electric current of the output electric current of the linear amplification unit and an output electric current of the switching amplification unit are added and outputted to a first load, and an electric current which flows into the linear amplification unit at the time of the correcting is supplied to a second load from a power supply terminal of the linear amplification unit.

13. The power supplying apparatus according to claim 12, wherein
the flowing direction and the magnitude of the output electric current of the linear amplification unit are found by detecting a potential drop caused by an electric resistance element arranged in series to an output path of the linear amplification unit.

14. The power supplying apparatus according to claim 12, wherein
the control signal generating unit includes at least one hysteresis comparator, and outputs a judging result based on the flowing direction and the magnitude of the output electric current of the linear amplification unit as the control signal.

15. The power supplying apparatus according to claim 11, wherein
the linear amplification unit is a voltage follower or a negative feedback amplifier, and a feed back signal is obtained from an output terminal.

16. The power supplying apparatus according to claim 11, wherein
the second load includes a plurality of blocks connected in parallel each other, and converts a power supply voltage of the linear amplification unit into a voltage corresponding to each of the plural blocks and connects the voltage to the corresponding block.

17. A transmitter which amplifies an input modulation signal including an amplitude modulation component and a phase modulation component, and outputs the amplified input modulation signal, comprising:
the power supplying apparatus according to claim 11;
an electric power amplifier connected as a first load of the power supplying apparatus; and
a configuration block connected as a second load, wherein
an amplitude modulation component of the input modulation signal is inputted into the power supplying apparatus, and the electric power amplifier works with using an output signal of the power supplying apparatus as a power supply, and amplifies the input modulation signal, and outputs the amplified input modulation signal.

18. A transmitter which amplifies an input modulation signal including an amplitude modulation component and a phase modulation component, and outputs the amplified input modulation signal, comprising:
the power supplying apparatus according to claim 11;
an electric power amplifier connected as a first load of the power supplying apparatus; and
a configuration block connected as a second load, wherein
an amplitude modulation component of the input modulation signal is inputted into the power supplying apparatus, and the electric power amplifier works with using an output signal of the power supplying amplifier as a power supply, and amplifies the phase component of the input modulation signal, and outputs the amplified phase component.

19. A control method of a power supplying apparatus which includes a switching amplification unit and a linear amplification unit, comprising:
supplying a first load with most of electric power by use of the switching amplification unit;
correcting an output voltage applied to the first load according to an input signal by use of the linear amplification unit; and
supplying an electric current which flows into the linear amplification unit at the time of the correcting to a second load from a power supplying terminal of the linear amplification unit.
